(19) United States
(12) Patent Application Publication
(10) Pub. No.: US 2013/0310509 A1
(43) Pub. Date: Nov. 21, 2013

(54) OPTICALLY ABSORPTIVE HEAT ACTIVATED ADHESIVE MASS AND ADHESIVE TAPE COMPRISING SAID TYPE OF ADHESIVE MASS

(71) Applicant: Tesa SE, Hamburg (DE)

(72) Inventors: FRANK HANNEMANN, HAMBURG (DE); ALEXANDER FISCHER, HAMBURG (DE); SVEN REITER, HAMBURG (DE); MARJI SMITH, SUNNYVALE, CA (US)

(21) Appl. No.: 13/890,614

(22) Filed: May 9, 2013

Related U.S. Application Data
(60) Provisional application No. 61/649,484, filed on May 21, 2012.

(51) Int. Cl. C09J 109/02

(52) U.S. Cl. CPC C09J 109/02
USPC 524/508

(57) ABSTRACT

Adhesive foil with at least one layer of a heat activated bondable adhesive mass comprising black pigments.

The invention relates to black dyed heat activated adhesive mass, in particular to be used for an adhesive foil for bonding metal parts on synthetic materials in portable consumer electronic items as well as adhesive tape structures comprising adhesive foils made of black heat activated adhesive masses.

### BACKGROUND OF THE INVENTION

Double-sided adhesive tapes are traditionally used for bonding metal parts on synthetic materials. The adhesive forces required for this purpose are adequate for the fixation and attachment of the metal parts on the synthetic materials. Steel, stainless steel as well as aluminum are preferably used as metals. The used synthetic materials include e.g. PVC, ABS, PC or blends based on these synthetic materials. However, the requirements for portable consumer electronics are constantly increasing. The size of these articles continues to diminish and hence the adhesive surfaces are becoming smaller as well. These circumstances are especially problematic for bonding metal on synthetic materials. This can be resolved in a particularly efficient manner by using heat activated foils which have the potential of developing a particularly high adhesive strength after the activation.

Heat activated adhesive masses such as they are also suitable as matrix for the adhesive foil according to the invention can essentially be classified into two categories, namely into thermoplastic heat activated adhesive masses and into reactive heat activated adhesive masses.

### a) Thermoplastic Heat Activated Adhesive Masses

These adhesive masses are not or only weakly self-adhesive at room temperature. The adhesive mass is only activated and becomes self-adhesive after exposure to heat. An analogously high glass transition temperature of the adhesive mass is responsible for this phenomenon, and therefore, the activation temperature to achieve adequate stickiness is—normally several dozens to hundreds of degrees Celsius—above room temperature. Thanks to the self-adhesive properties, an adhesive effect starts as early as before the mass starts hardening. After the adhesive partners are joined, the thermoplastic heat activated adhesive mass sets physically (use of suitable thermoplastic materials as adhesive mass; generally resulting in a reversible adhesion), and optionally also chemically (use of suitable thermoplastic reactive materials as adhesive mass; generally resulting in an irreversible adhesion) into a hardened state while it cools, such that the adhesive effect is conserved in cooled status where it has developed the actual adhesive strengths. The more heat, pressure and/or time are used for the adhesion, the stronger the bond between the materials to be bonded generally becomes. This regularly helps realize maximum bonding strengths under technically easy processing conditions.

The term thermoplastic polymers refers to those defined in Römpp (online version; version 2008, document ID RD-20-01271).

### b) Reactive Heat Activated Adhesive Masses

This term refers to polymer systems comprising functional groups such that a chemical reaction takes place when heat is supplied, wherein the adhesive mass sets chemically and hence brings about the adhesive effect. Generally, reactive heat activated adhesive masses do not become self-adhesive upon supply of heat and the adhesive effect therefore only sets in after the hardening. Frequently, reactive heat activated adhesive masses are not thermoplastic, but are only realized with an elastomer-reactive resin system (however, compare the heat activated foils using thermoplastic reactive materials; see above).

The glass transition temperature is not relevant for the functionality of reactive systems.

Adhesive masses are generally created with one or a plurality of polymers (the basic polymer component, referred to as basic polymer for simplicity's sake), wherein additional components are normally admixed to adjust the properties (such as for instance resins (tackifying resins and/or reactive resins), softening agents, etc.) and wherein optionally other additives can be admixed which have a positive impact on the properties of the adhesive mass.

Reactive heat activated foils possess a high dimensional stability, if the elastomer component has a high elasticity. In addition, it is necessary for the reactive resins, that a cross-linking reaction can take place which considerably increases the adhesive strength. Heat activated foils based on nitrile rubber and phenol resins can be used for this adhesive bonding, such as e.g. the commercially available product 8475 from the company tesa. However, the dependence of the adhesive strength on the hardening conditions is a disadvantage of said reactive heat activated foils. The requirements in this respect are particularly high because consumer electronic devices are mass-produced and hence the individual components are manufactured at extremely short cycle times.

The high viscous flow of the nitrile rubber conveys a high dimensional stability to the heat activated foil, enabling high adhesive strengths on metals and synthetic materials due to the cross-linking reaction.

Thermoplastic heat activated foils have been known for a long time and are based e.g. on polyesters or co-polyamides. Commercial examples can be obtained from the Companies 3M (for example products 615, 615S) or tesa (for example product tesa® 8462, 8444, 8466, 8468). However, said thermoplastic heat activated foils also have disadvantages compared to the reactive versions with respect to the use in portable consumer electronic items. This in particular relates to the “oozing behavior” when used with the application of pressure under temperature, because predominantly punched blanks are processed which subsequently change their shape.

Yet, they also have advantages, such as for instance the lower required pressure and temperature during the hot-pressing step compared to the nitrile rubber-based reactive systems.

The manufacture of a heat activated foil with opaque black color of the used adhesive mass in a fashion that allows the conservation of the property profile in the direct comparison with the undyed adhesive mass and in which the adhesive film products possess identical property profiles has not yet been successful in the past.

In view of the prior art, the object of the invention is to provide a heat activated adhesive foil for attaching metal parts on synthetic materials for portable consumer electronic articles, wherein the respective adhesive mass is dyed with opaque black color and the property profile is conserved in the direct comparison with the undyed adhesive mass and wherein the adhesive film products have identical property profiles.

### SUMMARY

According to the invention, the object is solved with an adhesive foil, comprising at least one heat activated adhesive mass to which black pigments have been added.

### DETAILED DESCRIPTION

Suitable black pigments include for example soot, organic azo dyes and/or chromium complexes. Examples of black pigments based on chromium complexes are [1-[(2-hydroxy-4-nitrophenyl)azo]-2-naphtalenolato(2-)][1-(2-hydroxy-5-nitrophenyl)azo]-2-naphthalenolato(2-)]chromate(1-), bis[1-[(2-hydroxy-4-nitrophenyl)azo]-2-naphthalenolato (2-)]chromate(1-) and bis[1-[(2-hydroxy-5-nitrophenyl)azo]-2-naphthalenolato(2-) ]chromate(1-).

Black pigments are preferably used in quantities where the ratio of black pigments in the dyed heat activated adhesive mass does not exceed 8% by volume. This allows the conservation of the adhesive properties of the adhesive mass, although it was not expected that said quantities would already result in the complete black coloration of the adhesive mass. Yet this was the case. In fact, it was determined that ratios as low as starting from 0.9% by volume of black pigment relative to the dyed adhesive mass result in a solid coloration. Particularly well-balanced heat activated adhesive masses with respect to the black coloration and adhesive properties can be obtained if black pigments in the range of 1.3 to 1.8% by volume are added to the dyed adhesive mass.

If soot particles are added as black pigments, they are preferably used at a quantity of up to 12% by weight relative to the dyed adhesive mass (i.e. the adhesive mass mixed with colored pigments). To achieve an excellent coloration, it is advantageous to use soot at a quantity of at least 1.2% by weight. If soot is used as black pigment, it is very preferably used at a quantity at which the resulting colored heat activated adhesive mass comprises soot at a weight ratio of 2.1 to 3.1% by weight. A quantity of 2.4% by weight of soot has proven particularly advantageous in the colored heat activated adhesive mass.

Soot can be added to the heat activated mass for example such that it is provided as pigment preparation in a resin matrix which chemically resembles or is at least compatible with (soluble in) the heat activated adhesive mass, such that the resin matrix of the pigment preparation of the adhesive mass matrix can ultimately be attributed to the colored heat activated adhesive mass. In this case, the amounts to be used can then preferably be adjusted such that the amount of soot in the adhesive mass corresponds to the ratios described above.

Both reactive heat activated adhesive masses as well as thermoplastic heat activated adhesive masses can be used as suitable heat activated adhesive masses according to the invention. It is very preferable to use reactive systems.

An adhesive mass on the basis of a mixture comprising at least one nitrile rubber S1 and one reactive component, in particular a reactive resin can preferably be used as reactive heat activated adhesive mass.

The weight component of the nitrile rubber S1 preferably ranges between 25 and 70% by weight, particularly preferably between 30 and 60% of the total composition of the reactive heat activated foil.

The nitrile rubbers S1 preferably comprise an acrylonitrile ratio of 15 to 45%. The Mooney viscosity is another criterion for the nitrile rubber S1. Because a high flexibility must be ensured with low temperatures, the Mooney viscosity should preferably be below 100 (Mooney ML 1+4 at 100° C.; corresponding to DIN 53523). A commercial example for said types of nitrile rubbers is e.g. Nipol™ N917 from the company Zeon Chemicals.

The term reactive resins in particular relates to short or medium chain oligomers or polymer compounds, in particular with medium molecular weights in the range up to 10,000 g/mol. The ratio of reactive resins in the heat activated adhesive preferably ranges between 75 and 30% by weight. A very preferred group comprises epoxy resins. The mean molecular weight M_{W} of the epoxy resins varies from 100 g/mol to a maximum of 10,000 g/mol for polymeric epoxy resins.

The epoxy resins comprise for example the reaction product consisting of Bisphenol A and epichlorohydrin, epichlorohydrin, glycidyl ester, the reaction product consisting of epichlorohydrin and p-amino phenol.

Preferred commercial examples are e.g. Araldite™ 6010, CY-281™, ECN™ 1273, ECN™ 1280, MY 720, RD-2 from Cyba Geigy, DER™ 331, DER™732, DER™ 736, DEN™432, DEN™438, DEN™ 485 from Dow Chemical, Epon™ 812, 825, 826, 828, 830, 834, 836, 871, 872, 1001, 1004, 1031, etc. from Shell Chemical and HPT™ 1071, HPT™ 1079 also from Shell Chemical.

Examples for commercial aliphatic epoxy resins are e.g. vinylcyclohexene dioxides, such as ERL-4206, ERL-4221, ERL-4201, ERL-4289 or ERL-0400 from Union Carbide Corp.

The following can be used as examples of Novolac resins: Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNipon Ink Chemistry or Epicote™ 152 from Shell Chemical.

Furthermore, melamine resins, such as e.g. Cymel™ 327 and 323 from Cytec can also be used as reactive resins.

In a very preferable procedural method, phenolic resins are used as reactive resins. For example, Novolac resins, resol-type phenolic resins or combinations of Novolac resins or phenolic resins are extremely suitable. Examples of commercially available phenolic resins are YP 50 from Toto Kasei, PKHC from Union Carbide Corp. and BKR 2620 from Showa Union Gosei Corp.

Moreover, terpene phenolic resins such as e.g. NIREZ™ 2019 from Arizona Chemical can be used as reactive resins.

Furthermore, polyisocyanates, such as e.g. Coronate™ L from Nippon Polyurethan Ind., Desmodur™ N3300 or Mondur™ 489 from Bayer can also be used as reactive resins.

In an advantageous embodiment of the adhesive foil according to the invention, adhesive strength-increasing (tackifying) resins are additionally added to the blend; very advantageously at a ratio of up to 30% by weight relative to the total mixture of the heat activated adhesive. All previously disclosed adhesive resins and those described in the literature can without exception be used as tackifying resins to be added. Pinene, indene and colophony resins, their disproportionate, hydrated, polymerized, esterified derivatives and salts, the aliphatic and aromatic hydrocarbon resins, terpene resins and terpene phenolic resins as well as C5-, C9-as well as other hydrocarbon resins are mentioned here for illustration purposes. Any combinations of these and other resins can be used to adjust the properties of the resulting adhesive mass as desired. All resins compatible (soluble) with the rubbers S1 can generally be used, where we would like to make reference specifically to all aliphatic, aromatic, alkylaromatic hydrocarbon resins, hydrocarbon resins on the basis of pure monomers, hydrated hydrocarbon resins, functional hydrocarbon resins as well as natural resins. Explicit reference is made to the description of the state of knowledge in the “Handbook of Pressure Sensitive Adhesive Technology” by Donatas Satas (van Nostrand, 1989).

Cross-linking and accelerating agents can optionally be added to the mixture to accelerate the reaction between the two components.

Suitable accelerating agents include e.g. imidazoles, commercially available under 2M7, 2E4MN, 2PZ-CN, 2PZ-CNS, P0505, LOIN from Shikoku Chem. Corp. or Curezol 2MZ from Air Products. In addition, HMTA (hexamethylenetetramine) additives are suitable as cross-linking agents.

In addition, amines, in particular tert. amines, can be used for acceleration purposes.

Softening agents can also be used in addition to reactive resins. Softening agents on the basis of polyglycol ethers, polyethylene oxides, phosphate esters, aliphatic carbonic acid esters and benzoic acid esters can be used here in a preferred embodiment of the invention. Moreover, aromatic carbonic acid esters, higher molecular weight diols, sulfonamides and adipinic acid esters can be used.

In a further preferred embodiment, other additives are added to the blend, such as e.g. polyvinyl formal, polyacrylate rubbers, chloroprene rubbers, ethylene propylene diene rubbers, methyl vinyl silicone rubbers, fluorosilicone rubbers, tetrafluoroethylene propylene copolymer rubbers, butyl rubbers, styrol butadiene rubbers.

Polyvinyl butyrals are available under Butvar™ from Solutia, under Pioloform™ from Wacker and under Mowital™ from Kuraray. Polyacrylate rubbers are available from Zeon under Nipol AR™. Chloroprene rubbers are available under Baypren™ from Bayer. Ethylene propylene diene rubbers are available under Keltan™ from DSM, under Vistalon™ from Exxon Mobile and under Buna EP™ from Bayer. Methyl vinyl silicone rubbers are available under Silastic™ from Dow Corning and under Silopren™ from GE Silicones. Fluorosilicone rubbers are available under Silastic™ from GE Silicones. Butyl rubbers are available under Esso Butyl™ from Exxon Mobile. Styrol butadiene rubbers are available under Buna S™ from Bayer, under Europrene™ from Eni Chem and under Polysar S™ from Bayer.

Polyvinyl formals are available under Formvar™ from Ladd Research.

In a further embodiment, thermoplastic polymers, preferably with a softening temperature of greater than 85° C. and smaller than 150° C. can be used as heat activated adhesive mass according to the invention.

Suitable thermoplastic polymers are e.g. polyesters and co-polyesters, polyamides and co-polyamides, thermoplastic polyurethanes, polyolefins, such as e.g. polyethylene (Hostalen®, Hostalen Polyethylen GmbH), polypropylene (Vestolen P®, DMS). No claim of completeness may be inferred from this list. Furthermore, blends made of different thermoplastic polymers can also be used as well as two different thermoplastic polymers (e.g. double-sided coating or different coating on both sides of a carrier fleece).

### Adhesive Foil Structures

In a preferred presentation, the dyed heat activated adhesive masses are offered in layer-shaped format, i.e. in the form of a heat activated adhesive foil. Said types of adhesive foils can be provided with a single layer (so-called transfer adhesive foils) or they can comprise a carrier, such that single- or double-sided adhesive foils containing a carrier are created.

In a particularly preferred fashion, single-layer or triple layer heat activated adhesive foils are used such that the total thickness of the adhesive foil is in the range of 25 to 750 μm, particularly preferred in the range of 30 to 250 μm, depending on the surface roughness, curvature or size of the substrates to be used for the adhesive bond. Said types of adhesive foils can for example be perfect for bonding metal parts on synthetic materials, metals on metals and synthetic materials on synthetic materials. In so doing, the synthetic materials should preferably be selected such that they are able to withstand the heat exposure required to activate the heat activated bondable adhesive foil undamaged.

In a preferred embodiment variant, the adhesive tape according to the invention consists of a carrier foil layer, preferably made of PET and in each case one heat activated adhesive mass layer dyed black on both sides of the carrier foil. Surprisingly, it has been determined that the development of scratches on activated substrate surfaces can be prevented during the hot-pressing step with a product containing a carrier, while this problem was observed with corresponding transfer adhesive foils. This means that the presence of a carrier foil in the heat activated adhesive foil additionally serves the purpose of a protective function with respect to the substrates to be bonded.

It is very advantageous if the adhesive tape is designed symmetrically (identical adhesive layer thicknesses and/or adhesive mass compositions and/or adhesive mass colorations on both sides of the carrier foil); however, the adhesive layers of the heat activated adhesive foil containing a carrier according to the invention can also be selected independently from each other with respect to their adhesive layer thicknesses and/or adhesive mass compositions and/or adhesive mass colorations.

In each case, the black adhesive mass layers preferably have a thickness of 5 μm to 250 μm. Very preferably, layer thicknesses of 30 μm, 50 μm, 60 μm, 100 μm, 125 μm, 150 μm, 200 μm and 250 μm are realized. As mentioned earlier above, the adhesive foils containing a carrier can be symmetrical, or the layer thicknesses of the two adhesive mass layers can be combined independently from each other; in so doing, it is particularly preferred if one each of the layer thicknesses mentioned above is selected.

The carrier foil preferably has a thickness between 5 and 250 μm, more preferably between 8 and 50 μm, most preferably between 12 and 36 μm and particularly preferably 23 μm. PET foils with a thickness of 23 μm have the advantage that they facilitate excellent adhesive properties for the double-sided adhesive tape, because the foil is ultra-flexible and well adjustable to the surface roughnesses of the substrates to be bonded.

Suitable carrier materials include common materials known to the person skilled at the art including foils (polyester, polyethylene terephthalate (PET), polyethylene (PE)—such as high density polyethylene (HDPE) or low density polyethylene (LDPE), polypropylene (PP), biaxially oriented polypropylene (BOPP), polyvinyl chloride (PVC), polyamide), fleece, foams, tissue and tissue foils as well as release paper (Glassine). In a particularly preferred procedural method, a double-sided heat activated bondable product according to the invention consists of a polyethylene terephthalate carrier foil and one heat activated adhesive foil dyed in black color each, preferably on the basis of a reactive system based on phenolic resin/nitrile rubber, on both sides of the carrier foil. Heat activated adhesive foils like the ones described above in this document are preferably used.

The carrier foils can be unstressed or comprise one or a plurality of preferred directions. Preferred directions are achieved by applying tension in one or in two directions. Anti-blocking agents, such as e.g. silicon dioxide, siliceous chalk or chalk, zeolites can be used for the manufacturing process e.g. of PET foils. The carrier foil itself can be transparent or semi-transparent or have a low light transmission ratio, for example due to coloration, in particular with black color. This can be added to the foil material for example with the admixture of color pigments. In particular soot can for example be used for the black coloration. However, the diameter of the pigments or particles should always be smaller than the final layer thickness of the carrier foil. Optimal colorations can be realized with particle ratios of 5 to 40% by weight relative to the foil material.

Moreover, the foils can be etched (e.g. trichloroacetic acid or trifluoroacetic acid), pre-treated with the corona or plasma method or equipped with a primer (e.g. Saran).

To manufacture the adhesive foils according to the invention, the adhesive masses are first preferably dyed with black color and shaped into adhesive films (adhesive mass layer), in particular with the use of temporary carrier materials (release liners). The heat activated adhesive films already dyed with opaque black color are then continuously laminated e.g. onto a 23 μm PET foil, preferably by means of concomitantly heated rolls at a temperature of a) 115° C.-135° C. and b) 140° C.-185° C. with v=10 m/min.

The softening point of polymeric compounds is indicated with respect to the Ring and Ball method with the corresponding use of the DIN EN 1427:2007 provisions (examination of the polymeric specimen instead of bitumen with otherwise identical execution of the method). The measurements are taken in the glycerol bath. The details about the softening point relate to the results of this measurement.

The mean molecular weight MW and polydispersity PD was determined by means of gel permeation chromatography (GPC). THF with 0.1% by volume of trifluoroacetic acid was used as eluent. The measurement was taken at 25° C. PSS-SDV, 5 μm, 103 Å (10-7 m), I.D. 8.0 mm×50 mm was used as precolumn. The columns PSS-SDV, 5 μm, 103 Å (10-7 m) 105 Å (10-5 m) and 106 Å (10-4 m) each with I.D. 8.0 mm×300 mm were used for the separation. The sample concentration was 4 g/L, the flow quantity 1.0 mL per minute. The measurements were taken in comparison to standard PMMA products.

### EXAMPLES

A pigment preparation of 40% by weight of soot in a phenolic resin matrix was prepared.

### Reference Example 1

50% by weight of Breon N41H80GR (nitrile rubber) from the company Zeon, 40% by weight of phenolic Novolac resin Durez 33040 admixed with 8% of HMTA (Rohm and Haas) and 10% by weight of the phenolic resole resin 9610 LW from the company Bakelite were produced as 30% solution in methyl ethyl ketone using a kneading apparatus. The kneading lasted 20 h. The heat activated adhesive mass was subsequently spread from the solution onto a Glassine release paper and dried for 10 minutes at 100° C. After the drying, the layer thickness was 30 μm.

### Reference Example 2

50% by weight of Breon N41H80GR (nitrile rubber) from the company Zeon, 40% by weight of phenolic Novolac resin Durez 33040 admixed with 8% of HMTA (Rohm and Haas) and 10% by weight of the phenolic resole resin 9610 LW from the company Bakelite were produced as 30% solution in methyl ethyl ketone using a kneading apparatus. The kneading lasted 20 h. The heat activated adhesive mass was subsequently spread from the solution onto a Glassine release paper and dried for 10 minutes at 100° C. After the drying, the layer thickness was 100 μm. Two of said layers were then joined at 100° C. using a roll laminator. The layer thickness after this procedure was 200 μm.

### Example 1

50% by weight of Breon N41H80GR (nitrile rubber) from the company Zeon, 40% by weight of phenolic Novolac resin Durez 33040 admixed with 8% of HMTA (Rohm and Haas) and 10% by weight of the phenolic resole resin 9610 LW from the company Bakelite were produced as 30% solution in methyl ethyl ketone using a kneading apparatus. The kneading lasted 20 h. The pigment preparation was then mixed by means of a paddle stirrer such that the ratio of soot in the adhesive mass was 2.4% by weight. The heat activated adhesive mass was subsequently spread from the solution onto a Glassine release paper and dried for 10 minutes at 100° C. After the drying, the layer thickness was 30 μm.

### Example 2

50% by weight of Breon N41H80GR (nitrile rubber) from the company Zeon, 40% by weight of phenolic Novolac resin Durez 33040 admixed with 8% of HMTA (Rohm and Haas) and 10% by weight of the phenolic resole resin 9610 LW from the company Bakelite were produced as 30% solution in methyl ethyl ketone using a kneading apparatus. The kneading lasted 20 h. The pigment preparation was then mixed by means of a paddle stirrer such that the ratio of soot in the adhesive mass was 8% by weight. The heat activated adhesive mass was subsequently spread from the solution onto a Glassine release paper and dried for 10 minutes at 100° C. After the drying, the layer thickness was 30 μm.

### Example 3

50% by weight of Breon N41H80GR (nitrile rubber) from the company Zeon, 40% by weight of phenolic Novolac resin Durez 33040 admixed with 8% of HMTA (Rohm and Haas) and 10% by weight of the phenolic resole resin 9610 LW from the company Bakelite were produced as 30% solution in methyl ethyl ketone using a kneading apparatus. The kneading lasted 20 h. The pigment preparation was then mixed by means of a paddle stirrer such that the ratio of soot in the adhesive mass was 2.4% by weight. The heat activated adhesive mass was subsequently spread from the solution onto a Glassine release paper and dried for 10 minutes at 100° C. After the drying, the layer thickness was 100 μm. Two of said layers were then joined at 100° C. using a roll laminator. The layer thickness after this procedure was 200 μm.

### Example 4

50% by weight of Breon N41H80GR (nitrile rubber) from the company Zeon, 40% by weight of phenolic Novolac resin Durez 33040 admixed with 8% of HMTA (Rohm and Haas) and 10% by weight of the phenolic resole resin 9610 LW from the company Bakelite were produced as 30% solution in methyl ethyl ketone using a kneading apparatus. The kneading lasted 20 h. The pigment preparation was then mixed by means of a paddle stirrer such that the ratio of soot in the adhesive mass was 8% by weight. The heat activated adhesive mass was subsequently spread from the solution onto a Glassine release paper and dried for 10 minutes at 100° C. After the drying, the layer thickness was 100 μm. Two of said layers were then joined at 100° C. using a roll laminator. The layer thickness after this procedure was 200 μm.

### Reference Example 3

Grilltex™ 1442 E from the company EMS-Grilltech (thermoplastic polymer on co-polymer basis; melting range of the polymer between 93° C. and 121° C.) according to manufacturer's specifications was pressed out to 100 μm between two layers of siliconized Glassine release paper in a hot press at 140° C.

### Reference Example 4

Grilltex™ 1442 E from the company EMS-Grilltech was pressed between two layers of siliconized Glassine release paper face and back on a paper fleece with a grammage of 13 g/m² in a hot press at 150° C. The layer thickness of the double-sided adhesive tape excluding the Glassine release paper was 150 μm. The penetration depth of the adhesive mass into the fleece was determined from both sides by means of REM imaging. The average layer thickness of the carrier fleece not penetrated by the hot-melt adhesive was determined in the process. This value is divided by the starting thickness of the carrier fleece and indicated in percent. In this example, an average soaking degree of 100% was determined, meaning that 100% of the sample was soaked with hot-melt adhesive.

### Example 5

Grilltex™ 1442 E from the company EMS-Grilltech was co-extruded with the pigment preparation in such a way that the ratio of soot in the adhesive mass amounted to 2.4% by weight after this procedure. The dyed adhesive mass was pressed to 150 μm between two layers of siliconized Glassine release paper in a hot press at 140° C.

### Example 6

Grilltex™ 1442 E from the company EMS-Grilltech was co-extruded with the pigment preparation in such a way that the ratio of soot in the adhesive mass amounted to 8% by weight after this procedure. The dyed adhesive mass was pressed to 150 μm between two layers of siliconized Glassine release paper in a hot press at 140° C.

### Example 7

Grilltex™ 1442 E from the company EMS-Grilltech was co-extruded with the pigment preparation in such a way that the ratio of soot in the adhesive mass amounted to 2.4% by weight after this procedure and the dyed adhesive mass was pressed between two layers of siliconized Glassine release paper front and back on a 13 g/m² paper fleece with a grammage of 13 g/m² in a hot press at 150° C. The layer thickness of the double-sided adhesive tape excluding the Glassine release paper was 150 μm. The penetration depth of the adhesive mass into the fleece was determined from both sides by means of REM imaging. The average layer thickness of the carrier fleece not penetrated by the hot-melt adhesive was determined in the process. This value is divided by the starting thickness of the carrier fleece and indicated in percent. In this example, an average soaking degree of 100% was determined, meaning that 100% of the sample was soaked with hot-melt adhesive.

### Example 8

Grilltex™ 1442 E from the company EMS-Grilltech was co-extruded with the pigment preparation in such a way that the ratio of soot in the adhesive mass amounted to 8% by weight after this procedure and the dyed adhesive mass was pressed between two layers of siliconized Glassine release paper front and back on a 13 g/m² paper fleece with a grammage of 13 g/m² in a hot press at 150° C. The layer thickness of the double-sided adhesive tape excluding the Glassine release paper was 150 μm. The penetration depth of the adhesive mass into the fleece was determined from both sides by means of REM imaging. The average layer thickness of the carrier fleece not penetrated by the hot-melt adhesive was determined in the process. This value is divided by the starting thickness of the carrier fleece and indicated in percent. In this example, an average soaking degree of 100% was determined, meaning that 100% of the sample was soaked with hot-melt adhesive.

The adhesive strength of the adhesive foils prepared as mentioned above is determined by means of a dynamic shear test using test specimens.

To manufacture the test specimens, two substrate disks are bonded with the adhesive foil to be analyzed. One of the substrate disks is an aluminum plate with a thickness of 1.5 mm and a size of 2 cm×10 cm; the other substrate disk is a polycarbonate plate with a thickness of 3 mm and an identical dimension of 2 cm×10 cm.

The adhesive foil samples on the basis of phenolic resin/nitrile rubber are laminated onto the aluminum plate with their untreated side, wherein a hot plate heated to 95° C. is used for the activation. The separating foil is subsequently removed. The adhesion of said bond on the polycarbonate plate is realized in a hot press, wherein the heat is applied to the aluminum side. The heat activation is carried out with a hot press plunger heated to 180° C. at a pressure of 10 bar for a pressing duration of 7 s.

The adhesive foil samples on the basis of thermoplastic heat-activated adhesive mass are laminated onto the aluminum with their untreated side with the use of a hot plate heated to 120° C. The separating foil is subsequently removed. The adhesion of said bond on the polycarbonate plate is realized in a hot press, wherein the heat is applied to the aluminum side. The heat activation is carried out with a hot press plunger heated to 150° C. at a pressure of 6 bar for a pressing duration of 7 s.

Next, the test specimens are torn apart in a lasting machine with 10 mm/min. using a gradually increasing force F. The measured unit is indicated in N/mm² and represents the maximum force (Fmax) measured to separate the test specimens (aluminum and polycarbonate). The measurement is conducted at room temperature—23° C.—and with a relative humidity of 50%.

The measurements are conducted immediately after the pressing and heat activation, with a pause of approx. 30 minutes to allow for acclimatization to the respective temperature range.

### RESULTS

The heat activated adhesive foils 1 to 8 according to the invention were tested analogously using the reference examples 1-4. Reference examples 1-2 represent heat activated foils based on pigment-free heat activated adhesives. Reference examples 3 and 4 represent heat activated foils based on pigment-free thermoplastic adhesives.

All examples were used under identical hardening conditions for bonding aluminum on polycarbonate (PC)—an application frequently used e.g. for the manufacture of cell phones.

The adhesive strengths were measured after the bonding. The adhesive bonding/hardening conditions were kept constant for

a) reactive heat activated foils

and

b) thermoplastic heat activated foils.

The results are illustrated in Table 1.

TABLE 1

| Examples | Fmax |
|---|---|
| Reference 1 | 6.5 N/mm² |
| Reference 2 | 7.8 N/mm² |
| Reference 3 | 5.8 N/mm² |
| Reference 4 | 4.2 N/mm² |
| 1 | 6.6 N/mm² |
| 2 | 5.3 N/mm² |
| 3 | 7.8 N/mm² |
| 4 | 5.9 N/mm² |
| 5 | 5.9 N/mm² |
| 6 | 4.6 N/mm² |
| 7 | 4.2 N/mm² |
| 8 | 3.4 N/mm² |

Table 1 illustrates that a full cover coloration was achieved in particular with a pigment quantity (soot) of 2.4% by weight in the adhesive mass, while the adhesive bonding properties are not impaired, whereas the adhesive strengths of the adhesive foils are still adequate, but noticeably worse with a quantity of 8% by weight in the heat activated adhesive mass.

Samples of the test specimens described above were additionally subject to the following program in a climate chamber: CCT=Climatic Change Test; heating up to +85° C./85% rel. h.; followed by the completion of 27 cycles ranging between +85° C./85% rel. h. and −40° C. and subsequent reheating to +85° C./85%; each complete cycle (85° C.→−40° C.→85° C.) lasted one hour.

The adhesive strengths of the test specimens were then re-evaluated based on the method described above. The values of the samples with a dye ratio of 2.4% by weight in the adhesive mass remain unchanged after the climatic change test as illustrated in the table below using 30 μm adhesive film with pigment preparation (“black”) and without pigment preparation (“nb”) as an example.

| Sample | Fmax |
|---|---|
| 30μ nb | 6.5 N/mm² |
| 30μ black | 6.6 N/mm² |
| 30μ nb CTT | 3.2 N/mm² |
| 30μ black CTT | 3.2 N/mm² |

Other analyses revealed that the surface resistance and the thermophysical parameters after the climatic change test also remain unchanged for the samples with a dye ratio of 2.4% by weight of soot in the adhesive mass.

The degree of blackening of the dyed heat activated adhesive masses was examined by means of a measurement according to EN ISO 11664-4. In the process, values in the following ranges of

L:≦30

a: <2 and >−2

b: <2 and >−2

were achieved and hence an excellent opaque black coloration realized for all examples according to the invention.

1. An adhesive foil comprising at least one layer of a heat activated bondable adhesive mass, which adhesive mass contains black pigments at a ratio of 0.9 to 8% by volume relative to the volume of the adhesive mass with pigment added.

2. An adhesive foil according to claim 1, wherein the adhesive mass comprises at least one nitrile rubber and at least one reactive resin.

3. An adhesive foil according to claim 1, further comprising a phenolic resin as reactive resin.

4. An adhesive foil according to claim 1, wherein the amount of black pigments is 1.3 to 1.8% by volume.

5. An adhesive foil according to claim 1, wherein said black pigment is soot.

6. An adhesive foil according to claim 5, wherein the soot is present in an amount of 1.2 to 12% by total weight of adhesive with added soot.

7. An adhesive foil according to claim 5, wherein the amount of soot is, 2.1 to 3.1% by weight.
